(19) United States
(12) Patent Application Publication
(10) Pub. No.: US 2024/0353616 A1
(43) Pub. Date: Oct. 24, 2024

(54) Optical Multiplex/Demultiplex Circuit and RGB Coupler

(71) Applicant: Nippon Telegraph and Telephone Corporation, Tokyo (JP)

(72) Inventors: Junji Sakamoto, Musashino-shi, Tokyo (JP); Yuji Fujiwara, Musashino-shi, Tokyo (JP); Kei Watanabe, Musashino-shi, Tokyo (JP); Toshikazu Hashimoto, Musashino-shi, Tokyo (JP)

(21) Appl. No.: 18/685,078

(22) PCT Filed: Oct. 1, 2021
(86) PCT No.: PCT/JP2021/036520

§ 371 Date: Feb. 20, 2024

(51) Int. Cl. G02B 6/12; G02B 6/125

(52) U.S. Cl. CPC G02B 6/12016; G02B 6/125; G02B 2006/12147; G02B 2006/12164

(57) ABSTRACT

A refractive index variation due to short wavelength and high power in a silica-based planar lightwave circuit (PLC) is suppressed. An optical multiplex/demultiplex circuit which include two waveguide, is made up of an asymmetric Mach-Zehnder interferometer (MZ) in which two arms having different lengths are formed between two coupler portions, and multiplexing and demultiplexing light of different wavelengths, wherein a second waveguide core width of an arm through which light on a short wavelength side propagates is larger than a first waveguide core width of the waveguide constituting the asymmetric MZ.

### TECHNICAL FIELD

The present invention relates to an optical multiplex/demultiplex circuit and an RGB coupler, and more particularly, to an optical multiplex/demultiplex circuit using an asymmetric Mach-Zehnder interferometer and an RGB coupler including the same.

### BACKGROUND ART

There is known a silica-based planar lightwave circuit (PLC) in which a core having a high refractive index and a clad having a low refractive index are formed on a substrate of Si or the like, using a film-forming technique of glass and a semiconductor microfabrication technique. Many optical devices to which a PLC is applied, such optical as communication splitters, wavelength multiplexers/demultiplexers, and optical switches, have been put into practical use. In recent years, PLC has been considered for application in the visible wavelength range, taking advantage of their transparency not only to light with a wavelength of 1.55 μm, which is used in optical communications, but also to visible light. For example, it is an RGB coupler that multiplexes red (R), green (G), and blue (B), which are the three primary colors of light (see, for example, PTL 1). The wavelengths of RGB are generally around R=638 nm, G=520 nm, and B=450 nm.

The RGB coupler is an optical circuit which multiplexes a plurality of light entering from each input port into one waveguide via a directional coupler and a mode coupler, and outputs the multiplexed light. Integrating laser diode (LD) bare chips corresponding to respective colors as an ultra-small RGB light source in each input port and applying them to smart glasses or the like is being studied. A specific optical multiplex/demultiplex circuit which multiplexes/demultiplexes light is configured by combining a directional coupler, a mode coupler, an asymmetric Mach-Zehnder interferometer (MZ), and a multimode interferometer (MMI).

FIG. 1 shows a configuration of a conventional RGB coupler. The RGB coupler 10 includes a B+G multiplex circuit made up of asymmetric MZ including waveguides 11 and 12, and a BG+R multiplex circuit made up of a mode coupler including waveguides 11 and 13 and an MMI 14. The PLC is generally transparent to the visible wavelength region, but since light is confined in a minute region of several microns, the energy density in the waveguide is very high. In particular, for light having a wavelength of high energy, such as purple or blue, the characteristic variation of the core has been confirmed (see, for example, NPL 1).

The characteristic variation of the core is considered to be caused by the formation of a color center due to two-photon absorption in dopants (including GeO₂, HfO₂ and the like) for refractive index adjustment, and becomes more remarkable as the wavelength is shorter and the power is higher. Further, the characteristic variation starts from a change in the refractive index (a rise in the refractive index), and when the change becomes large, it is observed as a loss (Kramers-Kronig relations). Therefore, in the circuit that utilizes the interference of light, the transmittance varies by the change in the interference state due to the change of the refractive index.

FIG. 2 shows a configuration of a conventional B+G multiplex circuit made of asymmetric MZ. The asymmetric MZ includes waveguides 11 and 12, and two arms having different lengths are formed between coupler portions 15 and 16. The asymmetric MZ realizes multiplexing and demultiplexing of light by utilizing interference of light controlled by a coupling rate of a coupler portion and an optical path length difference between the two arms. Here, the coupler portions 15 and 16 of the asymmetric MZ have a waveguide width of 1.75 μm, a gap of 1.5 μm, a core thickness of 2.0 μm, and a relative refractive index difference of Δ1% so that blue light is hardly coupled. In the case of the asymmetric MZ, when strong blue light propagates from the Port 2 to the waveguide 11, the refractive index of the arm 17 on one side including the waveguide 11 becomes high, and the optical path length difference is changed. As a result, the positions of the peaks and valleys of the spectrum are shifted with the change of the FSR of the asymmetric MZ. In particular, the B+G multiplex circuit having a short wavelength interval is sensitive to the refractive index variation and often becomes a bottleneck of characteristic variation.

FIG. 3 shows the transmittance when blue light is transmitted through the conventional B+G multiplex circuit. Blue light is made incident from the Port 2, and the output of the Port 4 is adjusted to 30 mW. Since the optical path length difference of the arm 17 on one side changes when blue light is input to the Port 2, for example, when green light is input, the peak position of the output spectrum shifts to the short wavelength side in a linear relationship with the light passage time. Therefore, if the PLC is continuously used under the conditions of short wavelength and high power, the application to the optical function circuit becomes a major problem due to the characteristic variation of the core. Although the description has been made using the asymmetric MZ, it goes without saying that if the refractive index changes in the directional coupler and the mode coupler, an optimum coupling condition cannot be obtained, and loss occurs.

### CITATION LIST

### Patent Literature

[PTL 1] WO 2017/142076

### Non Patent Literature

[NPL 1] Alireza T. Mashayekh, et al., “Miniaturized PIC multi-color laser engines for the life sciences,” Proc. SPIE 10922, Smart Photonic and Optoelectronic Integrated Circuits XXI, 109221U (4 Mar. 2019); doi: 10.1117/12.2507225

### Summary of Invention

An object of the present invention is to provide an optical multiplex/demultiplex circuit and an RGB coupler that can suppress a refractive index variation due to a short wavelength and high power in a PLC.

In order to achieve such an object, an aspect of the present invention is an optical multiplex/demultiplex circuit which includes two waveguides, is made up of an asymmetric Mach-Zehnder interferometer (MZ) in which two arms having different lengths are formed between two coupler portions, and multiplexes and demultiplexes light of different wavelengths, in which a second waveguide core width of an arm through which light on a short wavelength side propagates is larger than a first waveguide core width of the waveguide constituting the asymmetric MZ.

### BRIEF DESCRIPTION OF DRAWINGS

FIG. 1 is a diagram that shows a configuration of a conventional n RGB coupler.

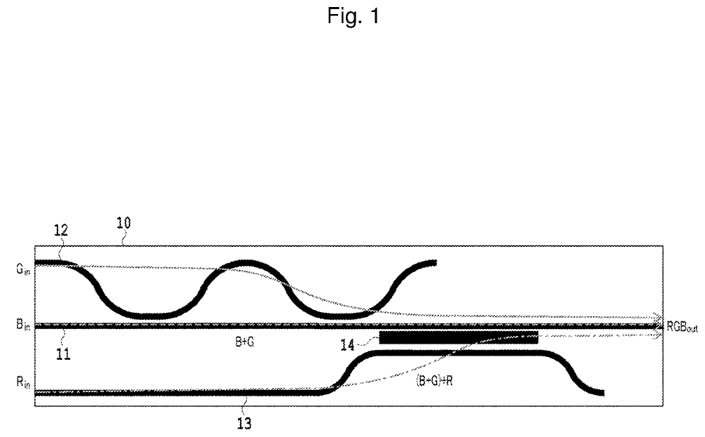

FIG. 2 is a diagram that shows a configuration of a conventional B+G multiplex circuit made of an asymmetric MZ.

FIG. 3 is a diagram that shows transmittance when blue light is transmitted through the conventional B+G multiplex circuit.

FIG. 4 is a diagram that shows transmittance when blue light and green light are transmitted through the conventional B+G multiplex circuit.

FIG. 5 is a diagram that shows a configuration of the B+G multiplex circuit according to example 1 of the present invention.

FIG. 6 is a diagram that shows a relationship between a waveguide width of an arm and a refractive index variation in the B+G multiplex circuit of example 1.

FIG. 7 is a diagram that shows a configuration of a B+G multiplex circuit according to example 2 of the present invention.

FIG. 8 is a diagram that shows a configuration of a B+G multiplex circuit according to example 3 of the present invention.

FIG. 9 is a diagram that shows a configuration of an RGB coupler according to example 4 of the present invention.

FIG. 10 is a diagram that shows a configuration of an RGB coupler according to example 5 of the present invention.

### DESCRIPTION OF EMBODIMENTS

Examples of the present invention will be described in detail below with reference to the drawings.

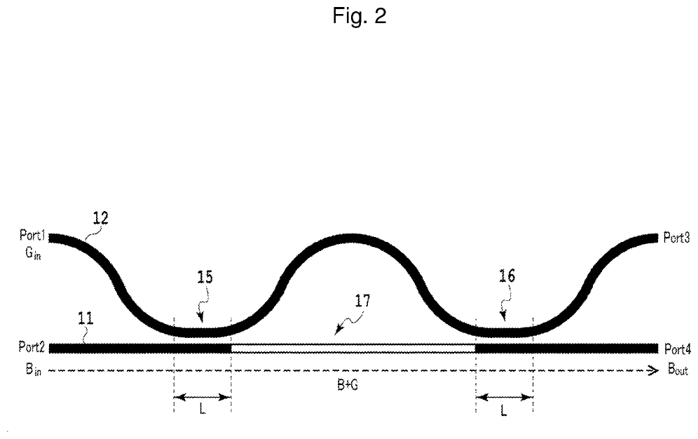

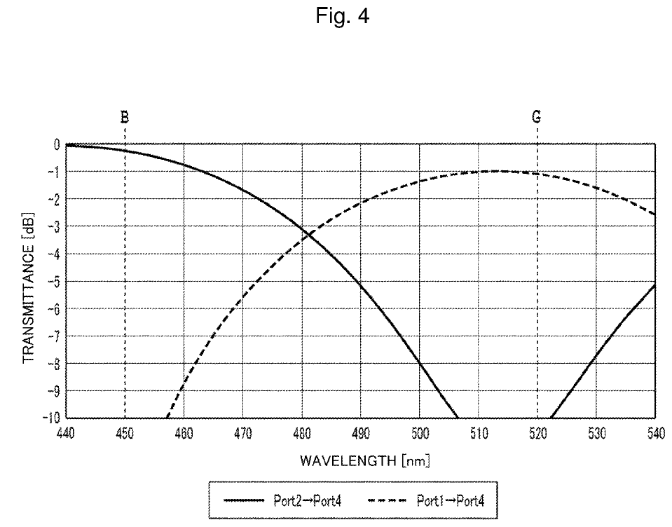

FIG. 4 shows the transmittance when blue light and green light are transmitted through the conventional B+G multiplex circuit. For comparison with example 1, the calculation results are obtained by a three-dimensional beam propagation method when blue light is input to a Port 2 and green light is input to a Port 1. In the conventional B+G multiplex circuit made of the asymmetric MZ shown in FIG. 2, a waveguide width of the waveguides 11 and 12 was set to 1.5 μm, a gap between the coupler portions 15 and 16 was set to 1.2 μm, a coupler length L was set to 300 μm, a core thickness was set to 2.0 μm, and a relative refractive index difference Δ was set to 1.0%. It can be seen that the circuit operates as a B+G multiplex circuit by representing the transmittance of the blue light output to the Port 4 and the transmittance of the green light output to the Port 4.

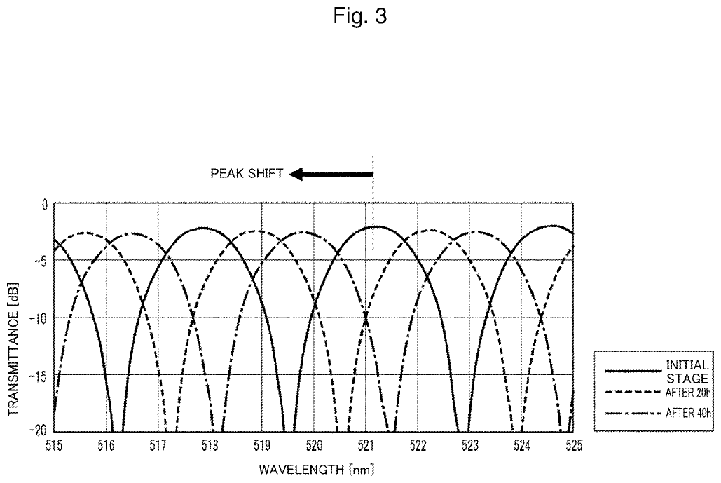

As described above, since the refractive index of the arm 17 on one side through which blue light propagates becomes high, and the optical path length difference changes, the transmittance varies. As a result, as shown in FIG. 3, a peak position of the output spectrum of the green light shifts toward the shorter wavelength side in a linear relationship with the light passage time.

### Example 1

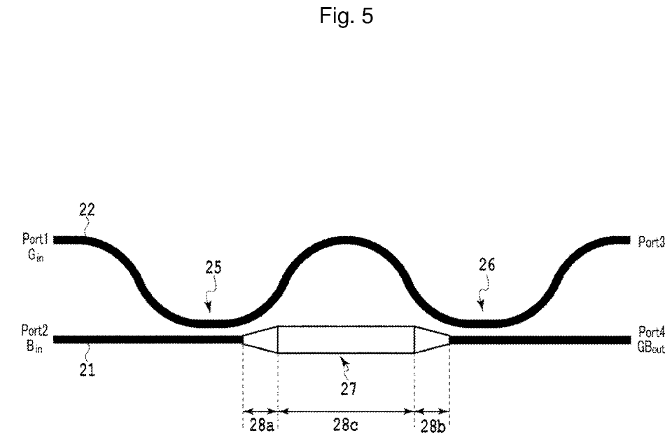

FIG. 5 shows a configuration of the B+G multiplex circuit according to Example 1 of the present invention. The B+G multiplex circuit is an asymmetric MZ made of two waveguides 21 and 22, and has two arms having different lengths between two coupler portions 25 and 26. The B+G multiplex circuit is a PLC made of a lower clad layer provided on an Si substrate, a core layer having a refractive index higher than that of the lower clad layer, and an upper clad layer provided on the core layer. The core layer includes a dopant for refractive index adjustment. The waveguides 21 and 22 include waveguide cores formed in a desired pattern, and the upper clad layer is provided to surround the waveguide cores. The waveguide widths of the waveguides 21 and 22 are 1.25 μm, and the dimensions of the coupler portions 25 and 26 are the same as in the conventional example described above.

In example 1, green light is input from the Port 1 to the waveguide 22, blue light is input from the Port 2 to the waveguide 21, and blue light and green light multiplexed from the Port 4 are output. A difference from the conventional example is that the waveguide core width of the arm 27 on one side through which blue light on the short wavelength side propagates is made larger than the waveguide core width of the waveguide 21. The shape of the arm 27 on one side has a waveguide width conversion part 28a which is a tapered waveguide in which a waveguide width of the coupler portion 25 gradually widens, a waveguide width expansion part 28c which has a prescribed thickness, and a waveguide width conversion part 28b which is a tapered waveguide which gradually narrows to the waveguide width of the coupler portion 26.

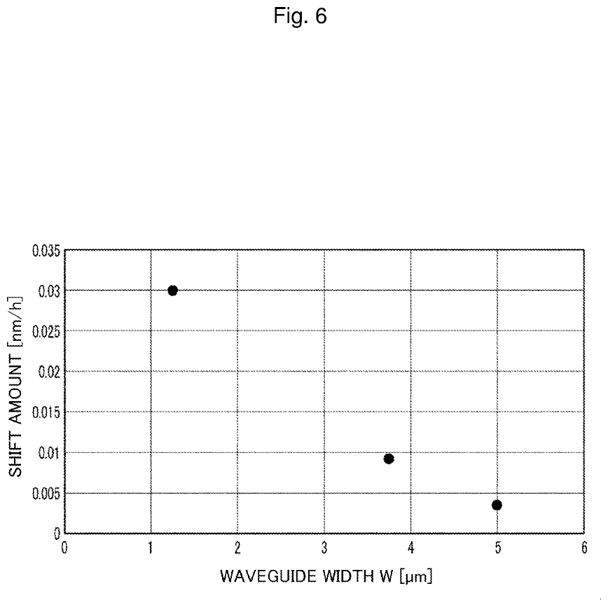

FIG. 6 shows a relationship between the waveguide width of the arm and the refractive index variation in the B+G multiplex circuit of example 1. A horizontal axis represents a waveguide width nm of the waveguide width expansion part 28c of the arm 27 on one side, and as shown in FIG. 3, a vertical axis represents a shift amount of the peak position of the output spectrum with respect to the light passage time in nm/h. It can be seen that the shift amount is suppressed to about 1/10, when the waveguide width is widened to 5.0 μm with respect to the shift amount of the waveguide width of 1.25 μm.

According to example 1, by making the waveguide core width of the arm through which the light on the short wavelength side of the asymmetric MZ propagates larger than the waveguide core width of the waveguide constituting the asymmetric MZ, the energy density of the light is reduced, and the change in the optical path length difference due to the variation of the refractive index can be suppressed.

As described above, the characteristic variation of the core is considered to be caused by the formation of a color center due to two-photon absorption in a dopant for refractive index adjustment. Therefore, in example 1, ZrO₂ is added to the core layer as a dopant having the least characteristic variation among oxides whose refractive index increases when added. According to the structure of the waveguide of example 1, even if conventional dopants (GeO₂, HfO₂ or the like exist) are used, the change in optical path length difference due to refractive index variation can be suppressed, but it is more preferable to apply ZrO₂.

In example 1, the arm 27 on one side includes waveguide width conversion parts 28a and 28b and a waveguide width expansion part 28c. The waveguide width conversion part 28a may be provided in the waveguide 21 on the input side of the coupler portion 25, and the waveguide width conversion part 28b may be provided in the waveguide 21 on the output side of the coupler portion 26. In the two coupler portions, the waveguide core width of the waveguide 21 which becomes an arm for propagating the light on the short wavelength side is made larger, and made equal to the waveguide core width of the waveguide width expansion part 28c. Thus, the characteristic variation is suppressed even in the coupler portion, and the same effect is obtained even for the variation of the optical path length. However, the coupling length of the coupler portion becomes long, and the multiplex circuit becomes large in size in the direction of the optical axis.

### Example 2

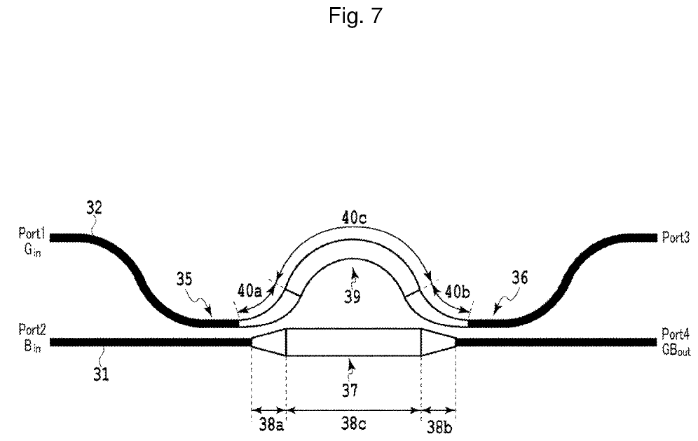

FIG. 7 shows a configuration of a B+G multiplex circuit according to example 2 of the present invention. The B+G multiplex circuit is an asymmetric MZ made of two waveguides 31 and 32, and has two arms having different lengths between two coupler portions 35 and 36. A difference from example 1 is that not only a waveguide core width (second waveguide core width) of the arm 37 on one side through which blue light propagates but also a waveguide core width (third waveguide core width) of the arm 39 on the other side is larger than a waveguide core width (first waveguide core width) of the waveguide constituting the asymmetric MZ. That is, the shape of the other arm 39 has a waveguide width conversion part 40a which gradually widens the waveguide width of the coupler portion 35, a waveguide width expansion part 40c having a prescribed thickness, and a waveguide width conversion part 40b which gradually narrows to the waveguide width of the coupler portion 36.

In the configuration of example 1, since blue light passes through a path from the Port 2 to the Port 4, only the waveguide core width of the arm 37 on one side is made thick. However, as described above, since the asymmetric MZ utilizes the interference of light, the blue light also passes through the other arm. Therefore, the width of the waveguide core of the other arm 39 is also increased, the energy density of light is lowered, and the change in the optical path length difference due to the variation of the refractive index is suppressed.

As shown in FIG. 6, since there is a correlation between the waveguide width and the shift amount, the waveguide core width is adjusted so that the amount of change in the optical path length of each arm is balanced with the amount of light passing through the two arms 37 and 39. In the configuration of the B+G multiplex circuit of example 2, a relationship of the first waveguide core width <the third waveguide core width <the second waveguide core width is satisfied. A size relationship of the waveguide core width differs depending on the wavelengths of the two lights to be multiplexed and the interference state of the lights. According to example 2, a structure having more resistance to blue light can be obtained.

### Example 3

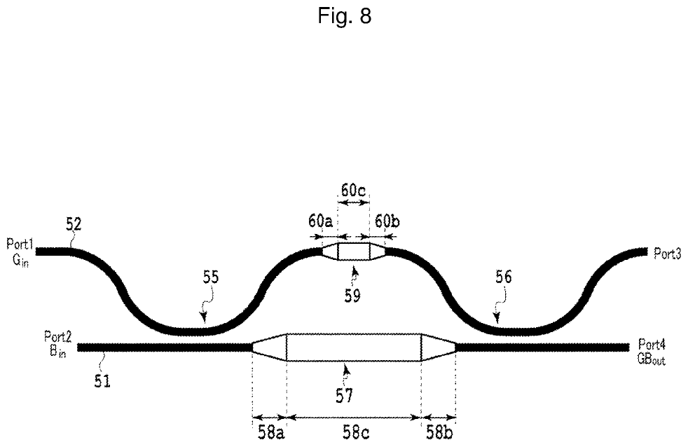

FIG. 8 shows a configuration of a B+G multiplex circuit according to example 3 of the present invention. The B+G multiplex circuit is an asymmetric MZ made of two waveguides 51 and 52, and has two arms having different lengths between two coupler portions 55 and 56. Although this example is the same as example 2 in that not only the waveguide core width of one arm 57 through which blue light propagates but also the waveguide core width of the other arm 59 are made larger, there is a difference in that a waveguide width expansion part 60c of the other arm 59 is provided in a straight line portion. That is, the waveguide width expansion parts of both arms are provided on the straight line portions of the respective arms.

As shown in FIG. 7 of example 2, if a bent portion of the arm is thickened, the excitation of the high-order mode is brought about. Then, the waveguide width expansion part 60c having a prescribed thickness is provided on the straight line portion of the arm. It is desirable that waveguide width conversion parts 60a and 60b for connecting the waveguide width expansion part 60c and the waveguide constituting the asymmetric MZ also be formed on the straight line portion of the arm.

### Example 4

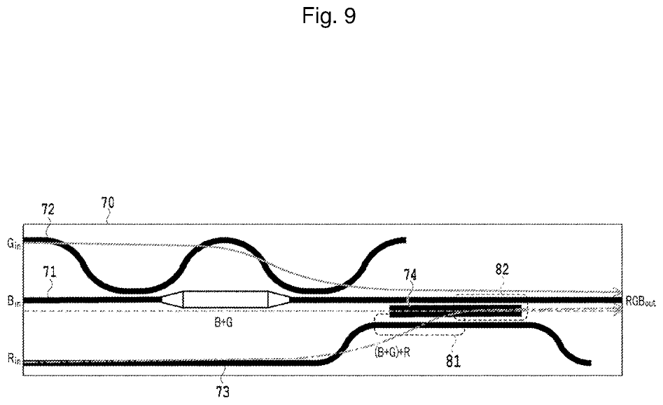

FIG. 9 shows a configuration of an RGB coupler according to example 4 of the present invention. The RGB coupler is obtained by adding an R coupler to the B+G multiplex circuits shown in examples 1 to 3. An RGB coupler 70 includes a B+G multiplex circuit made of asymmetric MZ including waveguides 71 and 72, and a BG+R multiplex circuit made of a mode coupler, including waveguides 71 and 73 and an MMI 74.

The waveguides 71 to 73 are single mode waveguides. The multiplexing in the B+G multiplex circuit is the same as those in the examples 1 to 3, and the multiplexing in the BG+R multiplex circuit will be described. Red light made incident from the waveguide 73 is converted into a high-order mode (for example, a primary mode) in a first coupling part 81, and is shifted to the MMI 74. Red light shifted to the MMI 74 is further converted into a fundamental mode (zero-order mode) in a second coupling part 82 and shifted to the waveguide 71. As a result, light obtained by multiplexing three wavelengths of RGB is output from an output end of the waveguide 71.

### Example 5

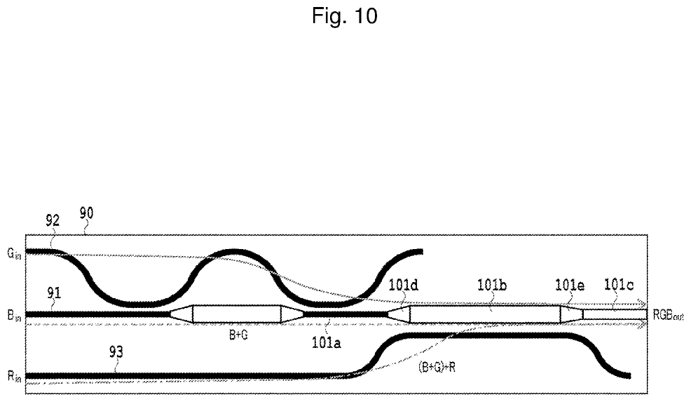

FIG. 10 shows a configuration of an RGB coupler according to example 5 of the present invention. The RGB coupler is obtained by adding an R coupler to the B+G multiplex circuits shown in examples 1 to 3. An RGB coupler 90 includes a B+G multiplex circuit made of asymmetric MZ including waveguides 91 and 92, and a BG+R multiplex circuit made of a directional coupler including waveguides 91 and 93.

The multiplexing in the B+G multiplex circuit is the same as those in examples 1 to 3, and the multiplexing in the BG+R multiplex circuit will be described. A waveguide 91 of the BG+R multiplex circuit includes first to third portions 101a to 101c having different waveguide widths. Each of the first to third portions 101a to 101c is coupled via waveguide width conversion parts 101d and 101e which are tapered waveguides. The waveguide widths of the waveguide 93 and the second portion 101b are set so that an effective refractive index in a zero-order mode of red light to the waveguide 93 is the same as an effective refractive index in a high-order mode of red light to the second portion 101b, and the effective refractive index in the high-order mode of each color light to the second portion 101b is not the same as the effective refractive index in the zero-order mode of each color light to the waveguide 93. As a result, light obtained by multiplexing three wavelengths of RGB is output from the output end of the third portion 101c of the waveguide 71.

In examples 4 and 5, red light is multiplexed after the B+G multiplex circuit. In the multiplexing obtained by the directional coupler, it is known that light the long wavelength side is easily transited, even if there is a mismatch in the effective refractive index. Therefore, the RGB coupler can perform multiplexing with high accuracy by multiplexing from the short wavelength side.

In the above examples, although the function as the optical multiplexer has been described by taking the RGB coupler as an example, the wavelength to be multiplexed is not limited to the above, and as long as the circuit is a circuit for multiplexing light of a so-called short wavelength, the operation and effect can be achieved. Furthermore, the present embodiment is not limited to the case of multiplexing because of the symmetry of light, but can also be applied to the case of demultiplexing.

1. An optical multiplex/demultiplex circuit which includes two waveguides, is made up of an asymmetric Mach-Zehnder interferometer (MZ) in which two arms having different lengths are formed between two coupler portions, and multiplexes and demultiplexes light of different wavelengths,
wherein a second waveguide core width of an arm through which light on a short wavelength side propagates is larger than a first waveguide core width of the waveguide constituting the asymmetric MZ.

2. The optical multiplex/demultiplex circuit according to claim 1, wherein the arm through which the light on the short wavelength side propagates includes a waveguide width expansion part having the second waveguide core width, and a waveguide width conversion part which is a tapered waveguide which connects the waveguide width expansion part and the waveguide having the first waveguide core width.

3. The optical multiplex/demultiplex circuit according to claim 1, wherein, in the two coupler portions, a waveguide core width of a waveguide serving as an arm through which the light on the short wavelength side propagates is made thicker to be equal to the second waveguide core width.

4. The optical multiplex/demultiplex circuit according to claim 1, wherein a third waveguide core width of an arm different from the arm through which the light on the short wavelength side propagates is thicker than the first waveguide core width and different from the second waveguide core width.

5. The optical multiplex/demultiplex circuit according to claim 4, wherein the portions of the different arms having the third waveguide core width are provided in a straight line portion.

6. The optical multiplex/demultiplex circuit according to claim 1, wherein the waveguide constituting the asymmetric MZ is a silica-based planar lightwave circuit, contains ZrO₂ as a dopant, and multiplexes/demultiplexes at least blue light.

7. An RGB coupler comprising:
the optical multiplex/demultiplex circuit according to claim 1 which multiplexes blue light and green light; and
a mode coupler which multiplexes an output of the optical multiplex/demultiplex circuit and red light.

8. An RGB coupler comprising:
the optical multiplex/demultiplex circuit according to claim 1 which multiplexes blue light and green light; and
a directional coupler which multiplexes the output of the optical multiplex/demultiplex circuit and red light.
